(19) United States
(12) Patent Application Publication
(10) Pub. No.: US 2019/0202099 A1
(43) Pub. Date: Jul. 4, 2019

(54) Shape-Memory Alloy Molding Parts

(71) Applicant: Becton, Dickinson and Company, Franklin Lakes, NJ (US)

(72) Inventors: Christina Rabolli, Mahwah, NJ (US); Liem Nguyen, Old Bridge, NJ (US)

(21) Appl. No.: 16/238,081

(22) Filed: Jan. 2, 2019

Related U.S. Application Data
(60) Provisional application No. 62/613,181, filed on Jan. 3, 2018.

(51) Int. Cl. B29C 45/44; B29C 45/73

(52) U.S. Cl. CPC B29C 45/4421; B29C 33/38; B29C 45/73

(57) ABSTRACT

A part for a mold is disclosed. The part includes a body formed of a shape-memory alloy. The body includes a first shape or first configuration at a first temperature and a second shape or second configuration at a second temperature. In one embodiment, the first shape includes at least one protrusion and the second shape is straight. A part of the present disclosure eliminates damage to a molded piece during removal of a molded piece from an injection mold by changing its shape in such a way that is suitable for part ejection.

### CROSS-REFERENCE TO RELATED APPLICATION

This application claims priority to U.S. Provisional Application Ser. No. 62/613,181 entitled “Shape-Memory Alloy Molding Parts” filed Jan. 3, 2018, the entire disclosure of which is hereby incorporated by reference.

### BACKGROUND OF THE INVENTION

### 1. Field of the Disclosure

The present disclosure relates generally to a part for a mold. More particularly, the present disclosure relates to a part for an injection mold and a method of removing the part of the mold from a molded piece.

### 2. Description of the Related Art

Injection molding generally involves introducing molten plastic under pressure into an area defined between a core part and a cavity part of an injection mold. The molten plastic injected into the area is allowed to cool and thereby solidify to form a molded piece. After the molded piece is formed, the core and cavity parts are separated to remove the molded piece. During part ejection, removal of the core part from the molded piece can cause damage and disfigurement to the molded piece, especially when an undercut is present.

### SUMMARY OF THE INVENTION

The present disclosure provides a part for a mold. The part includes a body consisting of a shape-memory alloy. The body includes a first shape or first configuration at a first temperature and a second shape or second configuration at a second temperature. In one embodiment, the first shape includes at least one protrusion and the second shape is straight. A part of the present disclosure eliminates damage to a molded piece during removal of a molded piece from an injection mold by changing its shape in such a way that is suitable for part ejection.

In accordance with an embodiment of the present invention, a part for a mold includes a body consisting of a shape-memory alloy, the body having a first shape at a first temperature and a second shape at a second temperature, wherein the second temperature is less than the first temperature.

In one configuration, the first shape includes at least one protrusion. In another configuration, the second shape is straight. In yet another configuration, the first temperature occurs in a heated mold. In one configuration, the second temperature occurs in a cooled mold. In another configuration, the shape-memory alloy has a transition temperature, the first temperature is above the transition temperature and the second temperature is below the transition temperature. In yet another configuration, the part comprises a core pin.

In accordance with another embodiment of the present invention, a part for a mold includes a body consisting of a shape-memory alloy, the body having a first configuration at a first temperature and a second configuration at a second temperature, wherein the second temperature is less than the first temperature.

In one configuration, the first configuration includes at least one protrusion. In another configuration, the second configuration is straight. In yet another configuration, the first temperature occurs in a heated mold. In one configuration, the second temperature occurs in a cooled mold. In another configuration, the shape-memory alloy has a transition temperature, the first temperature is above the transition temperature and the second temperature is below the transition temperature. In yet another configuration, the part comprises a core pin.

In accordance with another embodiment of the present invention, a method of removing a part of a mold from a molded piece includes selecting the part, the part comprising a body consisting of a shape-memory alloy, the body having a first shape at a first temperature and a second shape at a second temperature, wherein the second temperature is less than the first temperature; heating the mold to the first temperature thereby changing the body to the first shape; injecting a material into the mold to form the molded piece; cooling the mold to the second temperature thereby changing the body to the second shape; and removing the part from the molded piece with the part in the second shape.

In one configuration, the first shape includes at least one protrusion. In another configuration, the second shape is straight. In yet another configuration, the part comprises a core pin. In one configuration, the shape-memory alloy has a transition temperature, the first temperature is above the transition temperature and the second temperature is below the transition temperature.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1 is a side elevation view of a part having a first shape in accordance with an embodiment of the present invention.

FIG. 2 is a side elevation view of a part having a second shape in accordance with an embodiment of the present invention.

FIG. 3 is a cross-sectional view of a closed mold at a first temperature with a part having a first shape in accordance with an embodiment of the present invention.

FIG. 4 is a cross-sectional view of a closed mold at a first temperature with molten plastic injected and a part having a first shape in accordance with an embodiment of the present invention.

FIG. 5 is a cross-sectional view of a closed mold with a molded piece and a part having a first shape in accordance with an embodiment of the present invention.

FIG. 6 is a cross-sectional view of a closed mold at a second temperature with a molded piece and a part having a second shape in accordance with an embodiment of the present invention.

FIG. 7 is a cross-sectional view of an open mold with a part having a second shape removed from a molded piece in accordance with an embodiment of the present invention.

FIG. 8 is a cross-sectional view of a closed mold at a second temperature with a part having a second shape in accordance with an embodiment of the present invention.

FIG. 9 is a cross-sectional view of a closed mold at a first temperature with a part having a first shape in accordance with an embodiment of the present invention.

FIG. 10 is a side elevation view of a part having a first shape in accordance with another embodiment of the present invention.

FIG. 11 is a side elevation view of a part having a first shape in accordance with another embodiment of the present invention.

FIG. 12 is a side elevation view of a part having a first shape in accordance with another embodiment of the present invention.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

The present disclosure provides a part for a mold, e.g., an injection mold or other molding technologies. The part includes a body consisting of a shape-memory alloy. The body includes a first shape or first configuration at a first temperature and a second shape or second configuration at a second temperature. In one embodiment, the first shape includes at least one protrusion and the second shape is straight. A part of the present disclosure reduces damage to a molded piece during removal of a molded piece from an injection mold by rearranging its shape in such a way that is suitable for part ejection.

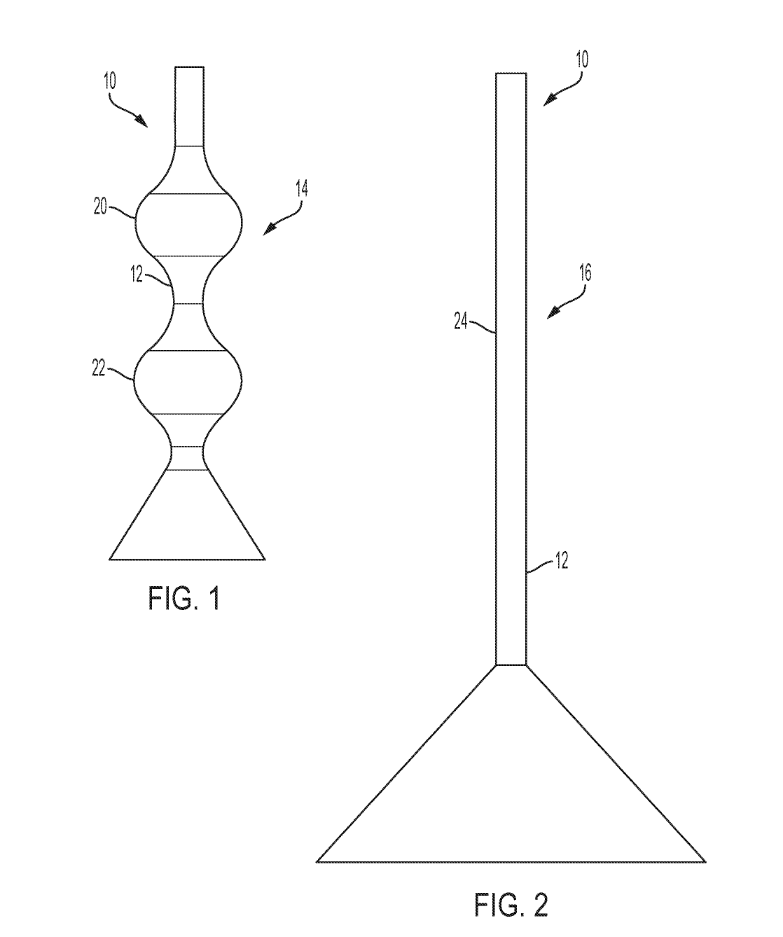

Referring to FIGS. 1 and 2, part 10 of the present disclosure includes a body 12 having a first shape or first configuration 14 (FIG. 1) at a first temperature and a second shape or second configuration 16 (FIG. 2) at a second temperature. In one embodiment, the second temperature is less than the first temperature, as described in more detail below.

In one embodiment, the body 12 of the part 10 consists of a shape-memory alloy. Shape-memory alloys are alloys that can toggle between two different shapes depending on the alloy's temperature. For example, above a shape-memory alloy's transition temperature, the shape-memory alloy takes on a first shape and below a shape-memory alloy's transition temperature, the shape-memory alloy takes on a second shape different from the first shape. These different shapes can be set during manufacturing to accommodate specific molding needs.

Alloys, e.g., components and their constituent amounts, can be altered to adjust the transformation temperature of a shape-memory alloy. This is important because a part 10 of the present disclosure formed of a shape-memory alloy must have a transition temperature suitable for molding applications. The transition temperature of the shape-memory alloy must be such that, when plastic is being injected into the mold, the shape-memory alloy will be above its transition temperature. For example, this first temperature occurs in a heated mold at a temperature above the transition temperature. At this first temperature in a heated mold, a body 12 of a part 10 of the present disclosure has a first shape or first configuration 14.

Then, as the material and the mold cools, the shape-memory alloy must move below its transition temperature to change shape and take a second shape or second configuration 16 that allows for a molded piece to be ejected from a mold without being damaged. For example, this second temperature occurs in a cooled mold at a temperature below the transition temperature. At this second temperature in a cooled mold, a body 12 of a part 10 of the present disclosure has a second shape or second configuration 16. In one exemplary embodiment, the second temperature is less than the first temperature.

In one exemplary embodiment, the body 12 of the part 10 of the present disclosure is formed of a Cu—Al—Ni alloy. This alloy includes a high transition temperature, e.g., around 180° C., which is necessary for molding and this temperature can be altered.

In another exemplary embodiment, the body 12 of the part 10 of the present disclosure is formed of a Fe-based alloy. This alloy has a resistance to high stresses, which are commonly encountered during injection molding.

In another exemplary embodiment, the body 12 of the part 10 of the present disclosure can be formed of other shape-memory alloys. Some examples include, but are not limited to: Ag—Cd, Au—Cd, Cu—Sn, Cu—Zn, Cu—Zn—Si, Cu—Zn—Al, Cu—Zn—Sn, Fe—Pt, Mn—Cu, Fe—Mn—Si, Co—Ni—Al, Co—Ni—Ga, Ni—Fe—Ga, Ti—Nb, Ni—Ti, Ni—Ti—Hf, Ni—Ti—Pd, Ni—Mn—Ga, or other alloys. Different alloys may be better suited to different molding applications, depending on the packing pressure, molding temperature, temperature at ejection, and other molding variables.

Referring to FIGS. 1 and 2, a part 10 of the present disclosure includes a body 12 having a first shape or first configuration 14 (FIG. 1) at a first temperature and a second shape or second configuration 16 (FIG. 2) at a second temperature. In one embodiment, the first shape 14 includes at least one protrusion 20 and the second shape 16 is straight, e.g., includes a straight portion 24. A part 10 of the present disclosure eliminates damage to a final molded piece 102 (FIGS. 4-7) during removal of the final molded piece 102 from an injection mold 200 by changing its shape in such a way that is suitable for part ejection.

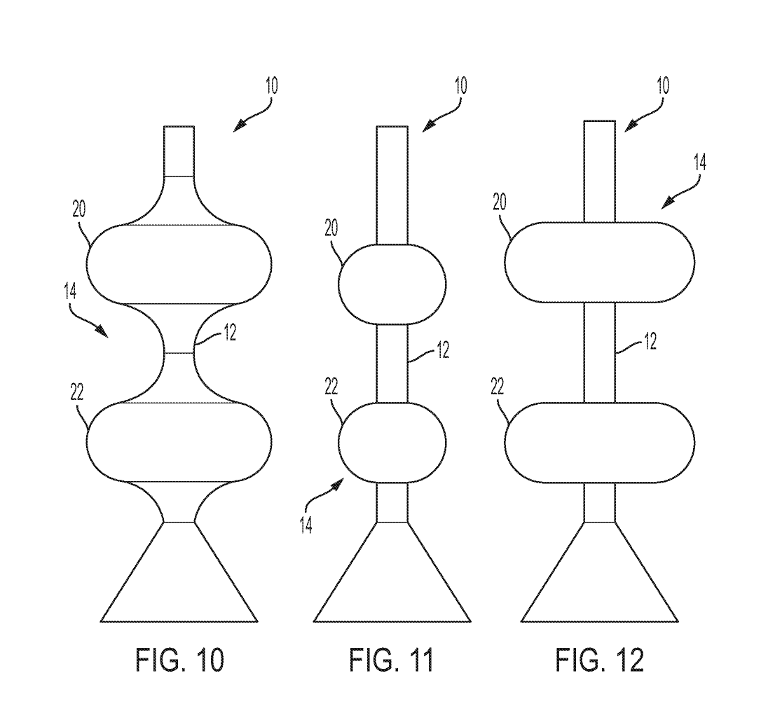

Referring to FIGS. 1 and 10-12, a first shape 14 of a body 12 of a part 10 of the present disclosure may include any shape or configuration for a variety of different molding applications. The first shape 14 is designed for molding a final molded piece 102 into a desired shape. For example, referring to FIGS. 4 and 5, the first shape 14 of the part 10 determines the final shape of a molded piece 102, as described in more detail below. In one exemplary embodiment, the first shape 14 of a body 12 of a part 10 of the present disclosure may take any shape or configuration to accommodate a desired molding application and a desired shape for a final molded piece 102.

In one exemplary embodiment, a first shape 14 of a body 12 of a part 10 of the present disclosure includes a first protrusion or first geometric portion 20. Referring to FIGS. 1 and 10-12, in exemplary embodiments, the protrusion 20 may be a bulbous portion, a spherical portion, a disk portion, or any other shaped portion to accommodate a desired molding application and a desired shape for a final molded piece 102. The protrusion 20 of the first shape 14 may comprise any shape or configuration to control the shape and geometry of a desired final molded piece 102. For example, in some embodiments, the protrusion 20 of the first shape 14 may be symmetrical. In other embodiments, the protrusion 20 of the first shape 14 may be asymmetrical and take on any geometrical shape or configuration that is needed to mold a final part 102 into a desired shape.

In one exemplary embodiment, a first shape 14 of a body 12 of a part 10 of the present disclosure also includes a second protrusion or second geometric portion 22. Referring to FIGS. 1 and 10-12, in exemplary embodiments, the second protrusion 22 may be a bulbous portion, a spherical portion, a disk portion, or any other shaped portion to accommodate a desired molding application and a desired shape for a final molded piece 102. The second protrusion 22 of the first shape 14 may comprise any shape or configuration to control the shape and geometry of a desired final molded piece 102. For example, in some embodiments, the second protrusion 22 of the first shape 14 may be symmetrical. In other embodiments, the second protrusion 22 of the first shape 14 may be asymmetrical and take on any geometrical shape or configuration that is needed to mold a final part 102 into a desired shape.

In some embodiments, a first shape 14 of a body 12 of a part 10 of the present disclosure may include any number of protrusions or geometrical portions. For example, the first shape 14 may include three geometrical portions, four geometrical portions, or more geometrical portions. A first shape 14 of a body 12 of a part 10 of the present disclosure can have any number of geometrical portions to control the shape and geometry of a desired final molded piece 102.

Referring to FIG. 2, a second shape 16 of a body 12 of a part 10 of the present disclosure may include any shape or configuration that is suitable for part ejection so that the second shape 16 of the part 10 eliminates damage to a molded piece 102 during removal of the molded piece 102 from a mold 200, such as an injection mold. In one exemplary embodiment, a second shape 16 of a body 12 of a part 10 of the present disclosure is straight, e.g., includes a straight portion 24. In this manner, the straight portion 24 allows the body 12 of a part 10 of the present disclosure to take a shape that allows for a molded piece 102 to be ejected from a mold 200 without being damaged.

In one exemplary embodiment, the part 10 of the present disclosure is a core pin 30. In other exemplary embodiments, the part 10 of the present disclosure can be other molding parts that are manufactured from a shape-memory alloy to accommodate a desired molding application and/or a desired shape for a final molded piece 102. Example mold components may include, but are not limited to, portions of the cavity, core, slides and inserts.

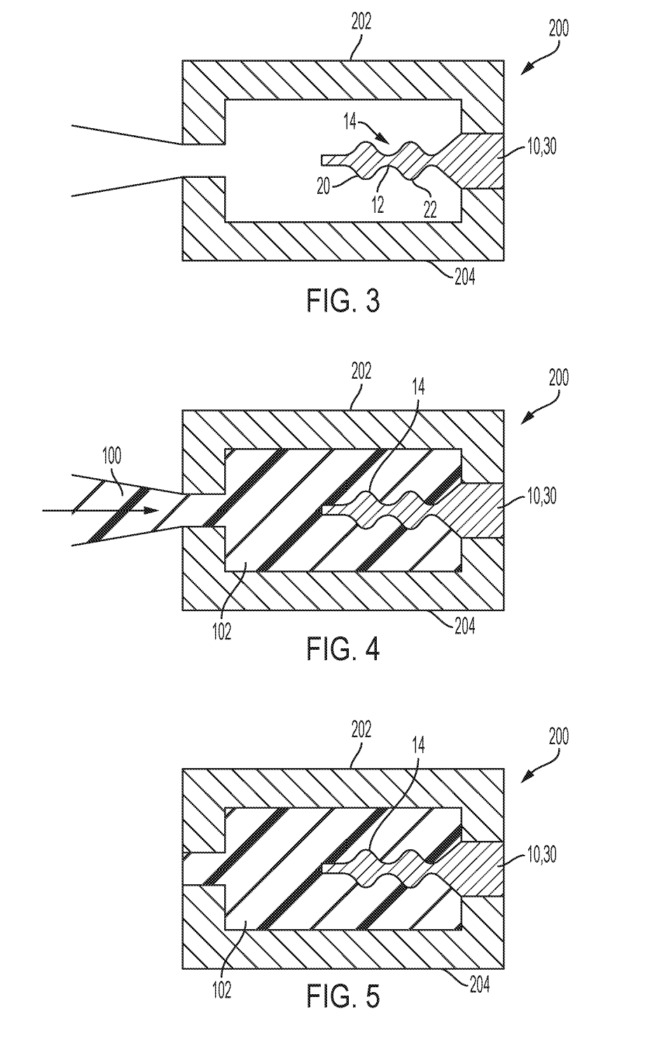

Referring to FIGS. 3-9, the manner in which a part 10 of the present disclosure is used to change shapes to allow for a plastic molded piece 102 to be ejected from a mold 200 without being damaged will now be discussed.

First, a user selects a part 10 for a mold and a desired molding application. The part 10 includes a body 12 consisting of a shape-memory alloy. The body 12 includes a first shape or first configuration 14 at a first temperature and a second shape or second configuration 16 at a second temperature. In one embodiment, the second temperature is less than the first temperature. In one embodiment, the part 10 of the present disclosure is a core pin 30. In other embodiments, the part 10 of the present disclosure may be other mold components.

Referring to FIG. 3, a mold 200, e.g., an injection mold or other molding technology, having a first cavity part 202, a second cavity part 204, and a part 10 of the present disclosure is in a closed mold position. A part 10 of the present disclosure can be compatible with any molding unit, e.g., any molding clamping units for opening and closing molding parts and/or dies and injection units for melting plastic by heat and then injecting molten plastic into a mold.

Referring to FIG. 3, in the closed mold position, the mold 200 is heated to prepare the mold 200 for melting a plastic and injecting a molten plastic into the mold 200. For example, a user heats the mold 200 to the first temperature, e.g., an injection temperature, that is above the transition temperature of the part 10 thereby changing the body 12 to the first shape 14.

Referring to FIG. 4, with the part 10 in the first shape 14, a material 100, e.g., a plastic, is injected into the mold 200 to form a final molded piece 102. As shown in FIG. 4, the first shape or first configuration 14 of the part 10 determines the flow of the molten plastic and the final shape of the final molded piece 102.

Referring to FIG. 5, after injection of the molten plastic, a cooling process begins. In FIG. 5, although the temperature is dropping, the temperature is still above the transition temperature and the part 10 is still in the first shape 14.

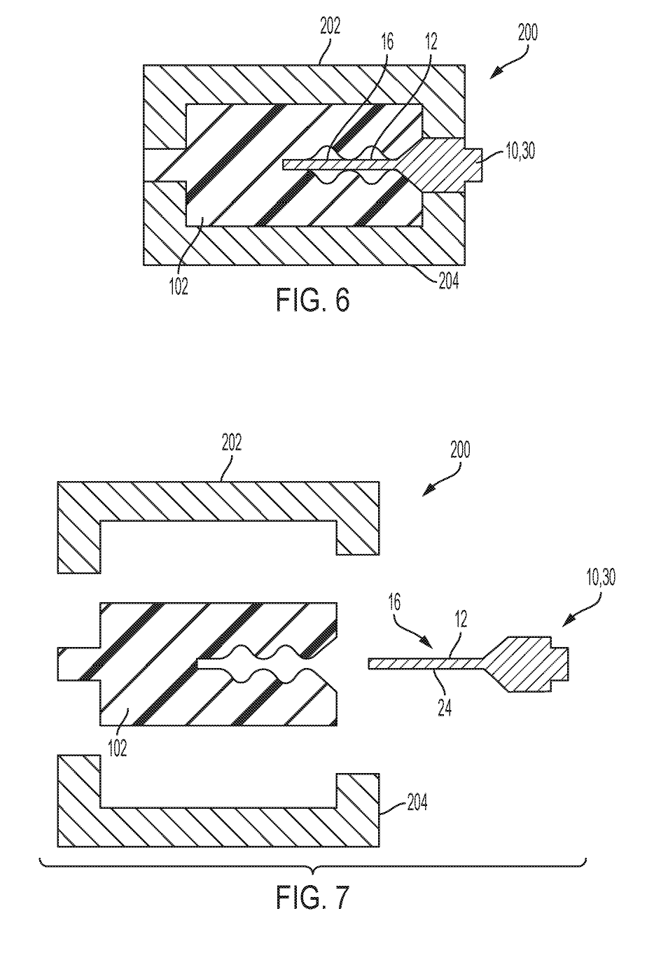

Referring to FIG. 6, as the cooling process continues, the temperature reaches a point, i.e., the second temperature, below the transition temperature. Once the temperature is below the transition temperature, the body 12 of the part 10 changes to the second shape 16. Thus, cooling the mold to the second temperature, e.g., a cooling temperature, that is below the transition temperature thereby changes the body 12 of the part 10 to the second shape 16.

Referring to FIGS. 6 and 7, with the part 10 of the present disclosure in the second shape 16, a user may easily remove the part 10 from the molded piece 102. As described above, the second shape or second configuration 16 is a shape or configuration that allows for a plastic molded piece 102 to be ejected from a mold 200 without being damaged. In one embodiment, the second shape 16 includes a straight portion 24. In this manner, the part 10 of the present disclosure is easily removed from the final molded piece 102 without contacting or damaging any portion of the final molded piece 102, as shown in FIGS. 6 and 7.

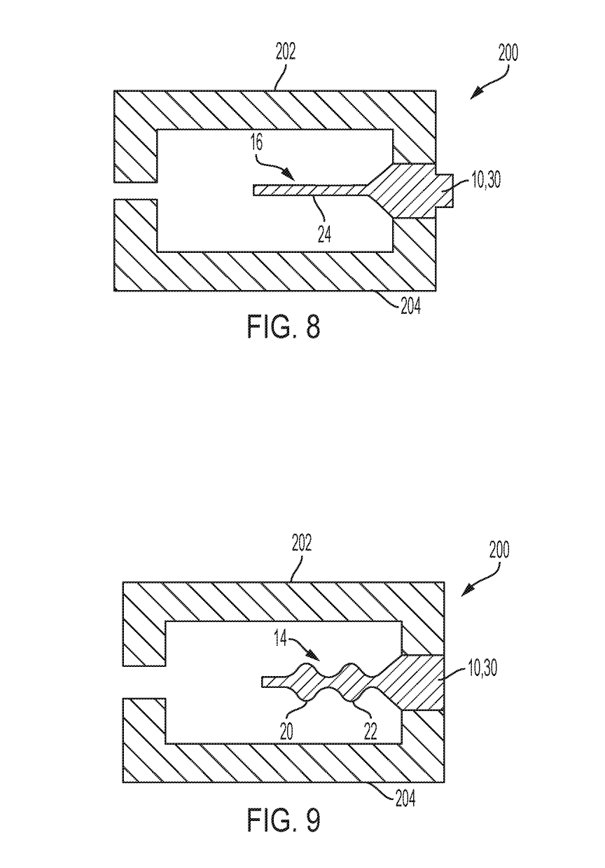

Referring to FIG. 8, a mold 200 is shown at a second temperature below the transition temperature, with the part 10 in the second shape or second configuration 16, before a subsequent molding application. Referring to FIG. 9, a mold 200 is shown heated to a first temperature above the transition temperature, with the part 10 in the first shape or first configuration 14, for another molding application.

In one exemplary embodiment, a final molded piece 102 may require an undercut. For example, undercuts in injection-molded plastic parts can be necessary or beneficial, such as to provide glue or adhesion anchors in pen needles, or other similar products. A part 10 of the present disclosure eliminates damage, e.g., smearing or deformation, to such a molded piece during removal of the molded piece from an injection mold by changing its shape in such a way that is suitable for part ejection, as described in detail above. A part 10 of the present disclosure also changes or removes restrictions on a maximum undercut size or a minimum corner radius for an undercut. Since a part 10 of the present disclosure can change and/or rearrange its shape for ejection, these restrictions are able to be reduced or removed.

A part 10 of the present disclosure enables molding applications where undercuts or other complicated geometries are necessary. This molding applications are enabled by a part 10 of the present disclosure as the first shape 14 of the part at a first temperature above the transition temperature occurring in a heated mold allows for molding of the intended final plastic part shape and then the part 10 is able to change to a second, easily removable, shape 16 as the part cools to a second temperature below the transition temperature occurring in a cooled mold, so that the final molded piece can be ejected without damaging the complicated molded geometry.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A part for a mold, comprising a body formed of a shape-memory alloy, the body having a first shape at a first temperature and a second shape at a second temperature, wherein the second temperature is less than the first temperature.

2. The part of claim 1, wherein the first shape has at least one portion at a location that is larger than the same portion at the same location of the second shape.

3. The part of claim 2, wherein the at least one portion at the location of the first shape has a diameter that is larger than the at least one portion of the second shape at the same location.

4. The part of claim 3, wherein the first temperature occurs in a heated mold.

5. The part of claim 4, wherein the second temperature occurs in a cooled mold.

6. The part of claim 1, wherein the shape-memory alloy has a transition temperature, the first temperature is above the transition temperature and the second temperature is below the transition temperature.

7. The part of claim 1, wherein the part comprises a core pin.

8. A part for a mold, comprising a body formed of a shape-memory alloy, the body having a first configuration at a first temperature and a second configuration at a second temperature, wherein the second temperature is less than the first temperature.

9. The part of claim 8, wherein the first shape has at least one portion at a location that is larger than the same portion at the same location of the second shape.

10. The part of claim 9, wherein the at least one portion at the location of the first shape has a diameter that is larger than the at least one portion of the second shape at the same location.

11. The part of claim 10, wherein the first temperature occurs in a heated mold.

12. The part of claim 11, wherein the second temperature occurs in a cooled mold.

13. The part of claim 8, wherein the shape-memory alloy has a transition temperature, the first temperature is above the transition temperature and the second temperature is below the transition temperature.

14. The part of claim 8, wherein the part comprises a core pin.

15. A method of removing a part of a mold from a molded piece, the method comprising:
selecting the part, the part comprising a body formed of a shape-memory alloy, the body having a first shape at a first temperature and a second shape at a second temperature, wherein the second temperature is less than the first temperature;
heating the mold to the first temperature thereby changing the body to the first shape;
injecting a material into the mold to form the molded piece;
cooling the mold to the second temperature thereby changing the body to the second shape; and
removing the part from the molded piece with the part in the second shape.

16. The method of claim 15, wherein the first shape has at least one portion at a location that is larger than the same portion at the same location of the second shape.

17. The method of claim 16, wherein the at least one portion at the location of the first shape has a diameter that is larger than the at least one portion of the second shape at the same location.

18. The method of claim 15, wherein the part comprises a core pin.

19. The method of claim 15, wherein the shape-memory alloy has a transition temperature, the first temperature is above the transition temperature and the second temperature is below the transition temperature.
